(19) United States
(12) Patent Application Publication
(10) Pub. No.: US 2014/0262081 A1
(43) Pub. Date: Sep. 18, 2014

(54) WINDOW SHADE ROLLER SUPPORT

(71) Applicant: Draper, Inc., Spiceland, IN (US)

(72) Inventor: Harold Seib, Greenfield, IN (US)

(21) Appl. No.: 14/208,729

(22) Filed: Mar. 13, 2014

Related U.S. Application Data
(60) Provisional application No. 61/784,079, filed on Mar. 14, 2013.

(51) Int. Cl. E06B 9/44

(52) U.S. Cl. CPC E06B 9/44
USPC 160/325; 29/428; 29/525.01; 160/405

(57) ABSTRACT

A shade roller support is provided to support a window shade. In an exemplary embodiment, the support includes a stationary pin, a housing attached to the shade roller, and a first and second bearing rotatably connecting the pin to the housing. The housing and bearings are positioned at least partially inside the shade roller.

### CROSS-REFERENCE TO RELATED APPLICATION

This application claims the benefit of U.S. Provisional Patent Application Ser. No. 61/784,079, filed Mar. 14, 2013, entitled WINDOW SHADE ROLLER SUPPORT to Harold Seib, the entire disclosure of which is expressly incorporated by reference herein.

### FIELD

The present disclosure relates to window shades, and more particularly to supports for rollers of a window shade.

One type of window shades includes rollers upon which fabric is wrapped. During use, the roller is rolled in one direction to lower the fabric and rolled in the opposite direction to wind up the fabric on the roller to raise the fabric.

### SUMMARY OF THE DISCLOSURE

In one exemplary embodiment, a shade roller support is provided to support a window shade. The support includes a stationary pin, a housing attached to the shade roller, and a first and second bearing rotatably connecting the pin to the housing. The housing and bearings are positioned at least partially inside the shade roller.

According to another embodiment of the present disclosure, a shade roller support assembly is provided. The assembly includes a shade roller having an interior and a first open end, a housing positioned in the first open end of the shade roller and positioned at least partially in the interior of the shade roller, a pin located partially in the interior of the shade roller and extending through the first open end of the shade roller, the shade roller and housing being able to freely rotate about the pin. A first bearing is positioned in the interior of the shade roller rotatably connecting the pin to the housing, and a second bearing is positioned in the interior of the shade roller rotatably connecting the pin to the housing.

According to another embodiment of the present disclosure, a shade roller support assembly is provided. The assembly includes a shade roller having an interior and a first open end, a housing positioned in the first open end of the shade roller, a pin located partially in the interior of the shade roller and extending through the first open end of the shade roller, the shade roller and housing being able to freely rotate about the pin. A first bearing rotatably connects the pin to the housing, and a second bearing rotatably connects the pin to the housing. The first and second bearings are spaced apart from each other along a longitudinal axis of the pin.

In a more particular embodiment of any of the above embodiments, the housing includes a first end portion, a second end portion, and a central portion located between the first and portion and the second end portion, the central portion having a smaller diameter than the first end portion and the second end portion. In a further more particular embodiment, the housing is substantially barbell shaped.

In a more particular embodiment of any of the above embodiments, the position of the housing is fixed relative to the shade roller along at least two contact edges in each of a clockwise direction and a counter-clockwise direction.

In a more particular embodiment of any of the above embodiments, the assembly further comprises a mounting bracket including a notch with an open end, the pin being configured to be non-rotatably inserted into the notch through the first open end of the shade roller.

In a more particular embodiment of any of the above embodiments, the housing has an exterior having a plurality of grooves and the interior of the shade roller has a plurality of projections. In a further particular embodiment, each of the plurality of projections is configured to be positioned within one of the plurality of grooves. In another particular embodiment, the shade roller includes an exterior and a shade attachment groove, the shade attachment groove being radially aligned with one of the plurality of projections in the interior of the shade roller.

In a more particular embodiment of any of the above embodiments, the shade roller and the housing are configured to freely rotate about the pin, and wherein the pin is unable to move relative to the housing in a direction along an axis of rotation of the housing.

In a more particular embodiment of any of the above embodiments, the assembly further comprises a fabric configured to be wrapped around the housing.

In a more particular embodiment of any of the above embodiments, the assembly further comprises a roller clutch operatively coupled to a second end of the shade roller. In a further more particular embodiment, the roller clutch is operatively coupled to a bead chain.

In a more particular embodiment of any of the above embodiments, the shade roller support assembly does not include a spring because the pin does not move longitudinally relative to the housing.

In another more particular embodiment of any of the above embodiments, a motor is positioned at least partially in the interior of the shade roller which provides rotational motion to the shade roller.

In a more particular embodiment of any of the above embodiments, a ratio of the diameter of the pin to the diameter of the shade roller is about 5.7.

In a more particular embodiment of any of the above embodiments, a ratio of the diameter of the pin to the diameter of the bearing is about 2.3.

In a more particular embodiment of any of the above embodiments, a ratio of the length of the pin to the length of the shade roller tube being is about 5:1 or higher.

In a more particular embodiment of any of the above embodiments, a ratio of the length of the pin to the length of the shade roller tube is about 20:1 or higher.

According to another embodiment of the present disclosure, a method of assembling a window shade is provided. The method includes positioning a support body having a first end and a second end around a shaft; coupling a first ball bearing set and a second ball bearing set to the shaft, the first and second ball bearing sets fixing the longitudinal position of the support body on the shaft, each ball bearing set including an inner race rotatably fixed with the shaft and an outer race configured to be coupled to the support body and rotate with the support body about the shaft; inserting at least a portion of the support body into a roller tube; and securing a fabric to the roller tube, the fabric being configured to roll on to the roller tube when the roller tube is rotated in a first direction and unroll from the roller tube when the roller tube is rotated in a second direction.

In a more particular embodiment, the method further comprises receiving the shaft in a bracket, the bracket being coupled to the shaft such that the bracket does not rotate relative to the shaft.

In a more particular embodiment, the support body includes a middle portion positioned between the first end and the second end, the middle portion having a diameter smaller than the diameter of the first end and the second end.

In another more particular embodiment, the support body has an exterior includes a plurality of grooves and the interior of the shade roller has a plurality of projections, and inserting at least a portion of the support body into the roller tube includes receiving the plurality of projections into the plurality of grooves.

In yet another more particular embodiment, securing the fabric to the roller tube includes receiving a portion of the fabric in a rib in the roller tube and securing the portion of fabric with adhesive or a fastening rod.

According to another embodiment of the present disclosure, a method of raising or lowering a window shade is provided. The method includes at least partially covering a window opening with a fabric, the fabric being configured to be wrapped around a roller tube, the roller tube operatively coupled to a roller clutch, the roller tube being coupled to a first bracket by the roller clutch and a second bracket by a roller support, the roller support including a shaft non-rotatably coupled to the bracket and first and second ball bearings rotatably coupling the shaft to the roller tube, the first and second ball bearings being positioned in an interior of the roller tube; and pulling an actuator extending from the roller clutch to a tensioner, the actuator configured such that pulling a first portion of the actuator unrolls the fabric from the roller tube and pulling a second portion of the actuator rolls the fabric on to the roller tube.

In a more particular embodiment, the actuator is a continuous loop actuator. In still a more particular embodiment, the actuator is a bead chain.

In a more particular embodiment, the fabric is movable between a fully raised position, a fully lowered position, and an intermediate position between the fully raised and lowered position.

### BRIEF DESCRIPTION OF THE DRAWINGS

The above-mentioned and other features of the disclosure, and the manner of attaining them, will become more apparent and the disclosure itself will be better understood by reference to the following description taken in conjunction with the accompanying drawings, wherein:

FIG. 1 is a diagrammatic view of a window shade in an architectural opening, such as a window, showing the window shade including a roller, fabric supported by the roller, a roller clutch supporting a left end of the roller, a roller support supporting a right end of the roller, and a bead chain (or other flexible actuation device) used to operate the window shade;

FIG. 2 is a perspective view of a roller support for use with the roller window shade of FIG. 1;

FIG. 3 is a perspective view of the roller support of FIG. 2 aligned with a bracket and roller tube; and

FIG. 4 is an assembly view of the roller support of FIG. 2 showing the various components of the roller support.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION

The embodiments disclosed herein are not intended to be exhaustive or to limit the disclosure to the precise forms disclosed in the following detailed description. Rather, the embodiments are chosen and described so that others skilled in the art may utilize their teachings.

According to the present disclosure, a window shade 10 is provided that includes a roller tube 14, fabric 16 wrapped on roller tube 14, roller clutch 18 coupled to roller tube 14, bead chain 20 coupled to roller clutch 18, and a tensioner 22 applying tension to bead chain 20. One end of roller tube 14 is typically supported by roller clutch 18 in a window opening 24 and the other end by a roller support 26 that provide rotational support of the ends of roller tube 14. Roller clutch 18 may be supported in window opening 24 by a separate bracket (not shown) or integrated with a bracket or otherwise configured to be supported in window opening 24. Window shade 10 may be positioned directly within window opening 24, adjacent to window opening 24, above window opening 24 or otherwise to block sunlight and/or air flow through window opening 24.

Normally, fabric 16 of window shade 10 is stationary in one of a fully raised position allowing more light to pass through window opening 24 into a room, a fully lowered position allowing less or none of the light to pass through window opening 24 into the room, or in an intermediate position between the fully raised and lowered positions. To change the position of fabric 16, a user pulls either side of bead chain 20 up or down to roll or unroll fabric 16 from roller tube 14.

Bead chain 20 is the preferred embodiment of a continuous loop actuator that extends between tensioner 22 and roller clutch 18. According to alternative embodiments, the actuator may be unbeaded, such as a cord, non-continuous, such as having one or more terminal ends, or other suitable actuator configurations known to those of ordinary skill in the art. Additional details of a suitable roller clutch 18 is provided in PCT Patent Publication No. WO2012/122108, titled ROLLER CLUTCH, to Harold Seib, filed Mar. 5, 2012, the entire disclosure of which is expressly incorporated by reference herein.

Roller support 26 is shown in greater detail in FIGS. 2-4 and includes a support body 28 and a shaft 30 extending through support body 28 and extending beyond one end thereof. According to the preferred embodiment of the present disclosure, support body is made of a plastic material and shaft 30 is made of chrome-plated steel.

Roller support further includes a snap ring 32, washer 34, first ball bearing 36, second ball bearing 38, washer 40, and snap ring 42. As shown in FIGS. 2 and 3, snap ring 32 is normally positioned in a groove 44 in shaft 30 to retain washer 34 on shaft 30. Similarly, snap ring 42 is normally positioned in a groove 46 in opposite end of shaft 30 to retain washer 40 on shaft 30.

During assembly, shaft 30 is press fit into one of ball bearings 36, 38, support body 28 is positioned over shaft 30, and the other one of ball bearings 38, 36 is press fit onto shaft 30. This press fit locks the longitudinal position of ball bearings 36, 38 onto shaft 30 and ball bearings 36, 38 trap support body 28 therebetween to likewise lock the longitudinal position of support body 28 on shaft 30. According to the preferred embodiment, roller support 26 does not include a spring because shaft 30 does not move longitudinally relative to support body 28. Later in assembly, washers 34, 40 are positioned over shaft 30 and snap rings 32, 42 are positioned in respective grooves 44, 46.

As shown in FIGS. 2-4, support body 28 is dumbbell shaped having first and second enlarged ends 48, 50 and a substantially smaller middle portion 52. First and second ends 48, 50 are sized to receive ball bearings 36, 38 and middle portion 52 is sized to receive shaft 30. As a result of the dumbbell shape, support body 28 includes wide groove or annular recess 54 positioned between enlarged first and second ends 48, 50. Additionally, the outer diameter of middle portion 52 is smaller than the outer diameter of ball bearings 36, 38. Because middle portion 52 extends between first and second enlarged ends 48, 50, first and second enlarged ends 48, 50 rotate together along with the outer races of first and second ball bearings 36, 38.

First end 48 of support body 28 has a larger diameter than second end 50. This larger diameter is provided by a disk or cap 56 that is larger than the inside and outside diameter of roller tube 14 so that first end 48 caps the open end 47 of roller tube 14.

During installation, support body 28 is positioned in roller tube 14 so that notches 49 in support body 28 align with ribs 51 in roller tube 14 and support body 28 is indexed into roller tube 14. One of larger rib 5 in roller tube 14 receive a portion of fabric 16. Adhesive and or a fastening rod is used to secure the portion of fabric 16 in this rib 51. As such, one of notches 49 of support body 28 may also receive a portion of fabric 16.

As shown in FIGS. 2-4, shaft 30 includes a pair of grooves 58 positioned on opposite sides of shaft 30. A bracket 60, which is mounted to window opening 24, includes a slot 62 defined by edges 64 that receives shaft 30 so that edges 64 are received by grooves 58. Grooves 58 have flat bottoms that abut edges 64 so that shaft 30 does not rotate relative to bracket 60 after installation. Rotation between roller tube 14 and shaft 30 (and bracket 60) is provided by ball bearings 36, 38 such that the inner race of ball bearings 36, 38 are stationary and the outer races of ball bearings 36, 38 rotate with support body 28 and roller tube 14.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this disclosure pertains.

1. A shade roller support assembly, the shade roller support assembly including:
a shade roller having an interior and a first open end;
a housing positioned in the first open end of the shade roller and positioned at least partially in the interior of the shade roller;
a pin partially located in the interior of the shade roller and extending through the first open end of the shade roller, the shade roller and the housing being able to freely rotate about the pin;
a first bearing positioned in the interior of the shade roller rotatably connecting the pin to the housing; and
a second bearing positioned in the interior of the shade roller rotatably connecting the pin to the housing.

2. The shade roller support assembly of claim 1, wherein the housing includes a first end portion, a second end portion, and a central portion located between the first and portion and the second end portion, the central portion having a smaller diameter than the first end portion and the second end portion.

3. The shade roller support assembly of claim 1, wherein the position of the housing is fixed relative to the shade roller along at least two contact edges in each of a clockwise direction and a counter-clockwise direction.

4. The shade roller support assembly of claim 1, further comprising a mounting bracket including a notch with an open end, the pin being configured to be non-rotatably inserted into the notch through the first open end of the shade roller.

5. The shade roller support assembly of claim 1, wherein the housing has an exterior having a plurality of grooves and the interior of the shade roller has a plurality of projections.

6. The shade roller support assembly of claim 5, wherein each of the plurality of projections is configured to be positioned within one of the plurality of grooves.

7. The shade roller support assembly of claim 6, wherein the shade roller includes an exterior and a shade attachment groove, the shade attachment groove being radially aligned with one of the plurality of projections in the interior of the shade roller.

8. The shade roller support assembly of claim 1, wherein the shade roller and the housing are configured to freely rotate about the pin, and wherein the pin is unable to move relative to the housing in a direction along an axis of rotation of the housing.

9. The shade roller support assembly of claim 1, further comprising a fabric configured to be wrapped around the housing.

10. The shade roller support assembly of claim 1, further comprising a roller clutch operatively coupled to a second end of the shade roller.

11. The shade roller support assembly of claim 10, wherein the roller clutch is operatively coupled to a bead chain.

12. A method of assembling a window shade, the method comprising:
positioning a support body having a first end and a second end around a shaft;
coupling a first ball bearing set and a second ball bearing set to the shaft, the first and second ball bearing sets fixing a longitudinal position of the support body on the shaft, each ball bearing set including an inner race rotatably fixed with the shaft and an outer race configured to be coupled to the support body and rotate with the support body about the shaft;
inserting at least a portion of the support body into a roller tube; and
securing a fabric to the roller tube, the fabric being configured to wind up the fabric on to the roller tube when the roller tube is rotated in a first direction and unroll the fabric from the roller tube when the roller tube is rotated in a second direction.

13. The method of claim 12, further comprising receiving the shaft in a bracket, the bracket being coupled to the shaft such that the bracket does not rotate relative to the shaft.

14. The method of claim 12, wherein the support body includes a middle portion positioned between the first end and the second end, the middle portion having a diameter smaller than the diameter of the first end and the second end.

15. The method of claim 12, wherein the support body has an exterior includes a plurality of grooves and the interior of the roller tube has a plurality of projections, and inserting at least a portion of the support body into the roller tube includes receiving the plurality of projections into the plurality of grooves.

16. The method of claim 12, wherein securing the fabric to the roller tube includes receiving a portion of the fabric in a rib in the roller tube and securing the portion of the fabric with adhesive or a fastening rod.

17. A method of raising or lowering a window shade, the method comprising:
at least partially covering a window opening with a fabric, the fabric being configured to be wrapped around a roller tube, the roller tube operatively coupled to a roller clutch, the roller tube being coupled to a first bracket by the roller clutch and a second bracket by a roller support, the roller support including a shaft non-rotatably coupled to the second bracket and first and second ball bearings rotatably coupling the shaft to the roller tube, the first and second ball bearings being positioned in an interior of the roller tube; and
pulling an actuator extending from the roller clutch to a tensioner, the actuator configured such that pulling a first portion of the actuator unrolls the fabric from the roller tube and pulling a second portion of the actuator winds up the fabric on to the roller tube.

18. The method of claim 17, wherein the actuator is a continuous loop actuator.

19. The method of claim 18, wherein the actuator is a bead chain.

20. The method of claim 18, wherein the fabric is movable between a fully raised position, a fully lowered position, and an intermediate position between the fully raised position and the fully lowered position.
